(19) United States
(12) Patent Application Publication
(10) Pub. No.: US 2025/0131595 A1
(43) Pub. Date: Apr. 24, 2025

(54) THREE-DIMENSIONAL CONTOUR SHAPE MEASURING SYSTEM

(71) Applicant: Young Optics Inc., HSINCHU CITY (TW)

(72) Inventors: Ching-Chao TSAI, HSINCHU CITY (TW); Wen-Yen HUANG, HSINCHU CITY (TW); Kao-Hui LIN, HSINCHU CITY (TW)

(21) Appl. No.: 18/607,861

(22) Filed: Mar. 18, 2024

(30) Foreign Application Priority Data
Oct. 18, 2023 (TW) 112139840

(51) Int. Cl. G06T 7/80; G01B 11/25; G06T 7/521; G06T 7/564

(52) U.S. Cl. CPC G06T 7/80; G01B 11/254; G06T 7/521; G06T 7/564

(57) ABSTRACT

A light source is used to project a structured light pattern onto a transparent piece under test. A first image sensing unit is used to obtain first image information of the structured light pattern on the transparent piece under test. A second image sensing unit is used to obtain second image information of the structured light pattern on the transparent piece under test. A processing unit includes a memory unit and a computing unit. The memory unit is used to store a correction parameter set, and the computing unit is used to receive the first image information and the second image information and obtain three-dimensional information of a surface of the transparent piece under test through the correction parameter set.

### FIELD

The present disclosure relates to an optical measurement system, and more particularly, to a three-dimensional contour shape measuring system.

### BACKGROUND

A three-dimensional measurement includes active measurement and passive measurement. Passive measurement includes binocular stereoscopic measurement. Its principle is similar to binocular stereoscopic vision. It uses two cameras to shoot from left and right of the same piece under test to obtain images from different viewing angles which are then used to calculate the positional deviation (parallax) between image pixels using the triangulation principle to obtain three-dimensional information of the piece under test. This process is similar to the human visual perception process.

Active measurement, such as structured light imaging measurement, its principle is to “actively” project a structured light pattern of a known pattern onto a surface of an object through a laser. The structured light pattern of the known pattern changes due to changing in the irradiation position, distance, incident angle and reflection angle of the laser light response to different surface heights and different normal directions are formed on a three-dimensional shape of the surface of the object. The deformed structured light pattern is obtained through the camera lens. The spatial position of each point of the pattern is obtained by mapping the deformed structured light pattern with the known pattern, and finally the spatial position of each point on the surface of the object is calculated based on the triangulation principle.

Taiwan Patent Publication No. TW202100943A discloses a heterodyne optical phase measurement device and a measurement method for a mirror surface. A structured light is projected onto a projection surface through a lens element and a sensor is used to capture an image and structured light of the sample to measure a three-dimensional structure of glass, plastic, and mirror-like metal materials. However, due to uneven roughness on the sample surface or image deformation caused by the measurement optical system, its measurement accuracy needs to be improved. Taiwan Patent Publication No. TW201514470A discloses a system and method for measuring the physical properties of semiconductor device components by structured light, including the following steps: (1) applying a structured light pattern to the adhesive material on the semiconductor device component; (2) obtaining a signal of an image of the structured light pattern on the camera; and (3) analyzing the image of the structured light pattern to determine the physical properties of the adhesive material. However, it cannot measure transparent parts, and the problem of improving measurement accuracy has not yet been solved.

### SUMMARY

In view of the above, the present disclosure provides a three-dimension measurement system to effectively solve the problems of accuracy in the prior art.

In order to achieve above-mentioned object of the present disclosure, one embodiment of the disclosure provides a three-dimension contour shape measuring system, including: a light source, a first image sensing unit, a second image sensing unit, and a processing unit. The light source is configured to project a structured light pattern onto a transparent piece under test. The first image sensing unit is disposed at a side of the transparent piece under test opposite to a side of the transparent piece under test facing the light source and is configured to obtain first image information of the structured light pattern on the transparent piece under test. The second image sensing unit is disposed at a side of the transparent piece under test opposite to a side of the transparent piece under test facing the light source and is configured to obtain second image information of the structured light pattern on the transparent piece under test. An included angle between an axis of the second image sensing unit facing the transparent piece under test and an axis of the first image sensing unit facing the transparent piece under test ranges from 20 degrees to 150 degrees. The processing unit is electrically connected to the first image sensing unit and the second image sensing unit. The processing unit includes a memory unit and a computing unit, the memory unit is configured to store a correction parameter set, and the computing unit is configured to receive the first image information and the second image information and obtain three-dimensional information of a surface of the transparent piece under test through the correction parameter set.

Another embodiment of the disclosure further provides a three-dimension contour shape measuring system, including: a display unit, a first image sensing unit, a second image sensing unit, and a processing unit. The display unit is configured to project a structured light pattern onto a surface of a transparent piece under test. The first image sensing unit is disposed at a side of the transparent piece under test away from the display unit and is configured to obtain first image information of the structured light pattern on the transparent piece under test. The second image sensing unit is disposed near by the first image sensing unit and is configured to obtain second image information of the structured light pattern on the transparent piece under test. An included angle between a central axis of the second image sensing unit and a central axis of the first image sensing unit ranges from 20 degrees to 150 degrees. The processing unit is electrically connected to the first image sensing unit and the second image sensing unit. The processing unit is configured to obtain three-dimensional information of the surface of the transparent piece under test by calculating with the first image information, the second image information, and a preset parameter.

In comparison with prior art, the disclosure three-dimension measurement system calibrates the result of three-dimension measuring by a correction parameter set or a preset parameter to obtain a more accuracy measuring result more quickly, such that the problems in prior art can effectively avoid.

### BRIEF DESCRIPTION OF DRAWINGS

FIG. 1 is a schematic view of a structure of a three-dimensional measurement system of one embodiment of the disclosure.

FIG. 2 is a schematic side view of the three-dimensional measurement system in FIG. 1;

FIG. 3 is a schematic view of a structure of a three-dimensional measurement system when measuring a standard part of one embodiment of the disclosure;

FIG. 4 is a schematic view of measuring a standard part of another embodiment of the disclosure;

FIG. 5 is a schematic view of a structure of a three-dimensional measurement system of another embodiment of the disclosure;

FIG. 6 is a schematic side view of the three-dimensional measurement system in FIG. 5; and

FIG. 7 is a schematic view of some gray code pattern.

### REFERENCE NUMERALS DESCRIPTION

100, 200: three-dimensional contour shape measuring system, 10: light source, 10′: display unit, 11: structured light patterns, 12: position adjustment mechanism, 13: projector, 14: projection screen, 21: first image sensing unit, 22: second image sensing unit, 30: processing unit, 31: memory unit, 32: computing unit, 33: circuit board, 40: transparent piece under test, 40S: standard part, 50: platform, 51: rotating device, 52: linear moving device, A1, A2: axis, CD: character dots, CPS: correction parameter set, D1: direction, S1: first image information, S2: second image information, STM: space to be measured, θi: included angle, θr: incident angle.

### DETAILED DESCRIPTION

In order to make the above and other objects, features, and advantages of the present disclosure more obvious and understandable, preferred embodiments of the present disclosure will be cited below, together with the drawings, for a detailed description as follows. Furthermore, the direction terms mentioned in this disclosure, such as up, down, top, bottom, front, back, left, right, inside, outside, side layer, surrounding, center, horizontal, transverse, vertical, longitudinal, axial, radial direction, the uppermost layer, or the lowermost layer, etc., are only directions for referring to the attached drawings. Therefore, the directional terms are used to explain and understand the present disclosure, but not to limit the present disclosure. In the figures, structurally similar units are denoted by the same reference numerals.

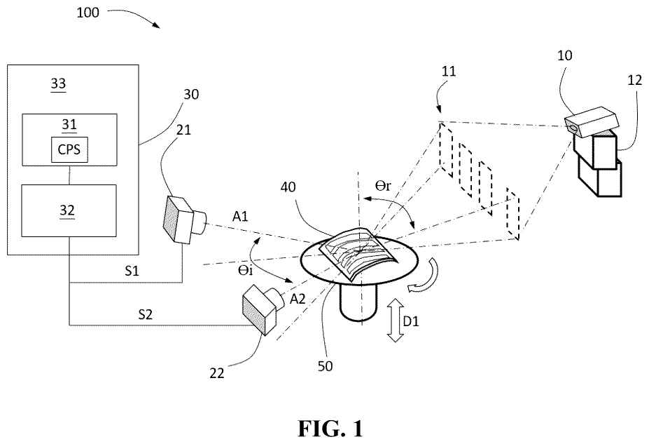

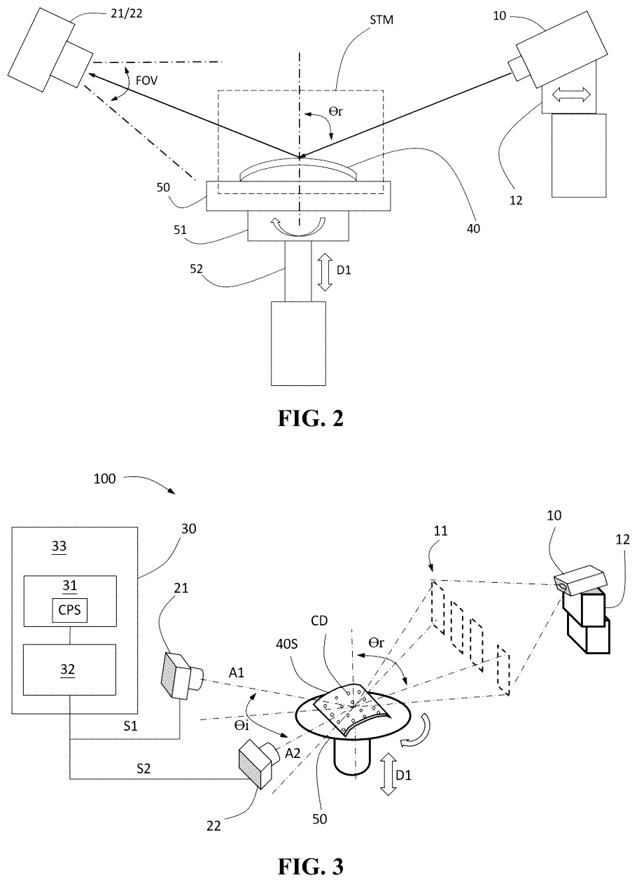

FIG. 1 shows a schematic diagram of a three-dimensional contour shape measuring system according to an embodiment of the disclosure. FIG. 2 shows a schematic side view of the three-dimensional contour shape measuring system in FIG. 1. Referring to FIGS. 1 and 2, the disclosure provides a three-dimensional contour shape measuring system 100, including: a light source 10, a first image sensing unit 21, a second image sensing unit 22, and a processing unit 30. The light source 10 is configured to project a structured light pattern 11 to a transparent piece under test 40. The first image sensing unit 21 is disposed at a side of the transparent piece under test 40 opposite to a side of the transparent piece under test 40 facing the light source 10 and is configured to obtain first image information S1 of the structured light pattern 11 on the transparent piece under test 40. The second image sensing unit 22 is disposed at a side of the transparent piece under test 40 opposite to a side of the transparent piece under test 40 facing the light source 10 and is configured to obtain second image information S2 of the structured light pattern 11 on the transparent piece under test 40. An included angle θi between an axis A2 of the second image sensing unit 22 facing the transparent piece under test 40 and an axis A1 of the first image sensing unit 21 facing the transparent piece under test 40 ranges from 20 degrees to 150 degrees. The processing unit 30 is electrically connected to the first image sensing unit 21 and the second image sensing unit 22. The processing unit 30 includes a memory unit 31 and a computing unit 32, the memory unit 31 is configured to store a correction parameter set CPS, and the computing unit 32 is configured to receive the first image information S1 and the second image information S2 and obtain three-dimensional information of a surface of the transparent piece under test 40 through the correction parameter set CPS.

In detail, the transparent piece under test 40 of the disclosure usually has a smooth surface to allow light to pass through. A smooth surface, such as a polished surface is as opposed to a diffusely reflective surface. It means that the diffuse reflection ratio of the surface of the piece under test is lower than a preset value, which is usually related to roughness of the surface of the piece under test. Because the piece under test with a low surface diffuse reflection ratio cannot generate sufficient energy of diffusely reflected light directly above the piece under test to form an image in the image sensing unit, or the energy of the diffusely reflected light is too low, resulting in blurred images, and resulting in Difficulties and errors in measurement. In detail, a piece under test with a high diffuse reflection ratio can also be adapted to the three-dimensional measuring method of the disclosure by reducing its surface diffuse reflection ratio through surface modification methods such as coating.

In detail, in one embodiment of the disclosure, the light source 10 is, for example, a laser light source, used to project a structured light pattern 11 on the surface of the transparent piece under test 40. Because the surface diffuse reflection ratio of the transparent piece under test 40 is low, the reflected image cannot be obtained directly above the transparent piece under test 40. The first image sensing unit 21 and the second image sensing unit 22 are disposed on the path after the structured light pattern 11 is reflected by the surface of the transparent piece under test 40 to obtain the reflected structured light pattern. That is, the transparent piece under test 40 is disposed at an intermediate position between the first image sensing unit 21 and the light source 10, and the transparent piece under test 40 is also disposed at an intermediate position between the second image sensing unit 22 and the light source 10. The second image sensing unit 22 is disposed near the first image sensing unit 21 to obtain images required for binocular stereoscopic measurement.

In detail, the included angle θi between the axis A2 of the second image sensing unit 22 facing the transparent piece under test 40 and the axis A1 of the first image sensing unit 21 facing the transparent piece under test 40 ranges from 20 to 150 degrees. The included angle θi cannot be too large, lest the structured light pattern reflected by the surface of the transparent piece under test 40 cannot fall within the field of view of the first image sensing unit 21 or the second image sensing unit 22.

In detail, the memory unit 31 can be used to load and store data and/or instructions for the above-mentioned system, for example. The memory unit/storage described above for one embodiment may include any combination of suitable volatile memories, such as dynamic random access memory (DRAM), and/or non-volatile memories, such as flash memory. The memory unit 31 may also include a USB disk, a mobile hard disk, a read-only memory (ROM), a random access memory (RAM), a floppy disk, or other types of media capable of storing program codes. The computing unit 32 may include circuitry such as, but not limited to, one or more single-core or multi-core processors. The above-mentioned processors may include any combination of general-purpose processors and special-purpose processors, such as graphics processors and application processors. The computing unit 32 may be coupled to the memory unit 31 and configured to execute instructions stored in the memory unit 31 to cause various applications and/or operating systems to execute on the above-mentioned system. In detail, the memory unit 31 is configured to store a correction parameter set CPS. The calculation unit 32 is configured to receive the first image information S1 and the second image information S2, and obtain the three-dimensional information of the surface of the transparent piece under test 40 through the correction parameter set CPS.

In one embodiment of the disclosure, the three-dimensional contour shape measuring system 100 further includes a platform 50 for placing the transparent piece under test 40. The platform 50 can move up and down along a vertical direction D1. In detail, in order to prevent the structured light pattern reflected by the surface of the transparent piece under test 40 from falling without the field of view FOV of the first image sensing unit 21 or the second image sensing unit 22, the platform 50 is adapted to move the transparent piece under test 40 up and down in a vertical direction D1 in a predefined space to be measured STM. When the transparent piece under test 40 is moved up and down in the vertical direction D1 in a predefined space to be measured STM, the phase of the structured light pattern reflected by the surface of the transparent piece under test 40 will change, so it is easier to judge the three-dimensional information of the surface. More accurate three-dimensional information can be obtained.

In one embodiment of the disclosure, the platform 50 further includes a rotating device 51 and a linear moving device 52. In detail, in order to prevent the structured light pattern reflected by the surface of the transparent piece under test 40 from falling without the field of view of the first image sensing unit 21 or the second image sensing unit 22. The linear moving device 52 is configured to move the transparent piece under test 40 up and down in the vertical direction D1 in a predefined space to be measured STM. The rotating device 51 is configured to rotate the transparent piece under test 40 in a predefined space to be measured STM. When the transparent piece under test 40 is moved or rotated in a predefined space to be measured STM, the phase of the structured light pattern reflected by the surface of the transparent piece under test 40 changes, making it easier to determine the three-dimensional information of the surface. More accurate three-dimensional information can be obtained. In detail, the rotating device 51 is, for example, a stepper motor. The linear moving device 52 is such as a voice coil motor or other actuator.

Please further refer to FIG. 3. In one embodiment of the disclosure, the correction parameter set CPS includes a first correction parameter set CPS1 and a second correction parameter set CPS2. The first correction parameter set CPS1 includes a mapping parameter PA1 between the spatial coordinates of the character dots CD of a standard part 40S and the image of the character dots CD obtained by the first image sensing unit 21 and the second image sensing unit 22. The second correction parameter set CPS2 includes mapping parameter PA2 between the phase of the structured light pattern 11 and the spatial coordinate of the character dots CD and the image of the structured light pattern 11 obtained by the first image sensing unit 21 and the second image sensing unit 22.

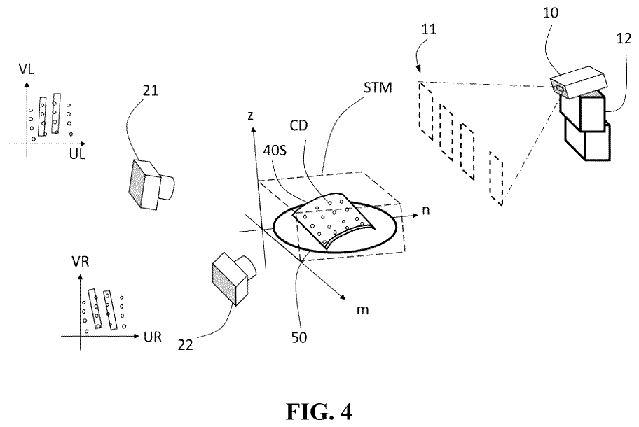

Referring to FIG. 3 and FIG. 4, in detail, the correction parameter set CPS is obtained as follows: first, providing a standard part 40S. A surface of the standard part 40S has three-dimensional changes, and coordinate values S (x, y, z) of each place on the surface of the standard part 40S in world coordinates have been accurately measured and obtained by other measuring equipment. Setting the character dots CD on the standard part. Actual coordinate values CD (x, y, z) of every character dot CD in the world coordinates can correspond to the coordinate value S (x, y, z) on the surface of the standard part 40S. The character dots CD may be drawn on the surface of the standard part 40S or attached to the surface of the standard part 40S. The standard part 40S is placed on the platform 50 of the three-dimensional contour shape measuring system 100, and image information of the character dots CD is obtained through the first image sensing unit 21 and the second image sensing unit 22. The coordinate information CD (UL, VL) and the coordinate information CD (UR, VR) of the character dots CD in the image coordinates can be obtained through calculation by the computing unit 32. The mapping parameter PA1 between actual coordinate value CD (x, y, z) of the character dots CD in the world coordinates and the coordinate information CD (UL, VL) in the image coordinates of the character dots CD obtained by the first image sensing unit 21 and the coordinate information CD (UR, VR) in the image coordinates of the character dots CD acquired by the second image sensing unit 22 can be calculated by using a high-order polynomial mathematical function through least square error fitting. In detail, in one embodiment of the disclosure, the mapping parameter PA1 can be expressed as follows:

$$x = f 1 ( Ur , Vr , Ul , Vl ) = c 0 + c 1 * Ur + c 2 * Vr + c 3 * Ul + c 4 * Vl + c 5 * Ur 2 + c 6 * Vr 2 + … \qquad ( 1 )$$

$$x = f 2 ( Ur , Vr , Ul , Vl ) = d 0 + d 1 * Ur + d 2 * Vr + d 3 * Ul + d 4 * Vl + d 5 * Ur 2 + d 6 * Vr 2 + … \qquad ( 2 )$$

$$x = f 1 ( Ur , Vr , Ul , Vl ) = e 0 + e 1 * Ur + e 2 * Vr + e 3 * Ul + e 4 * Vl + e 5 * Ur 2 + e 6 * Vr 2 + … , \qquad ( 3 )$$

where c0-c6 . . . , d0-d6 . . . , e0-e6 . . . , . . . are coefficients of the fitting mapping parameter.

Then, the structured light pattern is projected onto the standard part 40S. The space to be measured STM can be assigned coordinate axes (m, n, z) of the space to be measured to represent the position of each location in the space to be measured STM. Please further refer to FIG. 2. The rotating device 51 and the linear moving device 52 are used to rotate or move the platform 50, so that phase P (m, n) of the structured light pattern obtained by the first image sensing unit 21 and the second image sensing unit 22 changes. The image information of the character dots CD are obtained through the first image sensing unit 21 and through the second image sensing unit 22. Please refer to FIG. 1. Through calculation by the computing unit 32, the structured light pattern code and its phase change AP (m, n) on the character dot CD can be obtained respectively, and a high-order polynomial mathematical function is used to fit with the least square error. To calculate, the coordinates of the character dots CD can be calculated based on the phase of the structured light pattern 11 and the image information obtained by the first image sensing unit 21 and the second image sensing unit 22, and the mapping parameter PA2 of the calculated coordinates and the actual coordinate value CD (x, y, z) in the world coordinates can be obtained. In detail, in one embodiment of the disclosure, the mapping parameter PA2 can be expressed as follows: In each unit of z,

$$Δ P ( mr , nr ) = g 1 ( x , y ) \qquad ( 4 )$$

$$CD ( UR , VR ) = g 2 ( x , y ) \qquad ( 5 )$$

$$Δ P ( ml , nl ) = g 3 ( x , y ) \qquad ( 6 )$$

$$CD ( UL , VL ) = g 4 ( x , y ) \qquad ( 7 )$$

Referring to FIGS. 1 and 2, when measuring the three-dimensional features of the transparent piece under test 40, the transparent piece under test 40 is placed on the platform 50, the structured light pattern 11 is projected onto the surface of the transparent piece under test 40, and the rotating device 51 and The linear moving device 52 rotates or moves the platform 50 to obtain the first image information S1 of the structured light pattern 11 on the transparent piece under test 40 through the first image sensing unit 21 and obtain the second image information S2 of the structured light pattern 11 on the transparent piece under test 40 through the second image sensing unit 22. Through calculation by the computing unit 32, the position (ul, vl) and phase difference ΔP (ml, nl) of the pattern code of the structured light pattern 11 in the image coordinates in the first image sensing unit 21 and the position (ur, vr) and phase difference ΔP (mr, nr) of the pattern code of the structured light pattern 11 in the image coordinates in the second image sensing unit 22 can be obtained. Because the pattern codes of the structured light pattern 11 and its corresponding world coordinate value are known, the height value z of each position in the world coordinate, that is, the three-dimensional information of the surface of the transparent piece under test 40, can be calculated by using the first correction parameter set CPS1 and the second correction parameter set CPS2.

In detail, for a certain pattern encoding, the linear moving device 52 can be used to move the platform 50 in the D1 direction to measure its image position (ur, vr) and phase difference ΔP (mr, nr) at different height values z. At the same time, the coordinates (x, y) of the pattern encoding are known. Therefore, we can obtain mapping relationship between the ΔP (mr, nr) and image position (UR, VR) of the coordinates (x, y) at different height z and the world coordinate values (x, y, z) of object surface from the mapping parameter PA2 in the second correction parameter set CPS2 to obtain corrected three-dimensional information of the surface.

In detail, the structured light pattern 11 is projected on the surface of the transparent piece under test 40. The first image information S1 of the structured light pattern 11 on the transparent piece under test 40 is obtained through the first image sensing unit 21. The second image information S2 of the structured light pattern 11 on the transparent piece under test 40 is obtained through the second image sensing unit 22. The three-dimensional information of the transparent piece under test 40, that is, the three-dimensional coordinate values (x, y, z) of each location in the world coordinates, can be calculated by the computing unit 32 with the structured light pattern. However, measurement errors may be produced by distortion caused by the lens, uneven roughness on the surface of the transparent piece under test 40, and other factors. Therefore, if the standard part 40S with known three-dimensional information (world coordinate values) of various locations is used for calibration before measuring the piece under test 40, a more accurate measurement result can be obtained. However, it is difficult to actually use the first image sensing unit 21 and the second image sensing unit 22 to measure and correct every part of the standard part 40S. In addition to the data being too large and the calculation time taking too long, it is actually difficult to identify every position on the standard part 40S from the first image information S1 or the second image information S2. Therefore, a limited number of character dots CD are marked on the standard part, and only these character dots CD are measured and corrected, and other positions are approximated using methods such as interpolation. Better computing speed and data volume can be achieved. The first correction parameter set CPS1 calculated by measuring the standard part 40S can obtain the correction information of the binocular stereo measurement method, that is, the mapping relationship and their correction amounts between the three-dimensional information of image coordinates of the character dot positions in the first image information S1 and the second image information S2 and the three-dimensional information of image coordinates at other locations to the world coordinates. The correction information of the structured light pattern measurement method can be obtained through the second correction parameter set CPS2, that is, the mapping relationship and their correction amount between the three-dimensional information of the image coordinates of the character dot position and the image coordinates of other positions calculated by the structured light pattern and the three-dimensional information of the world coordinates. Therefore, when actually measuring the transparent piece under test 40, the measured first image information S1 and the second image information S2 can be corrected with the first correction parameter set CPS1 to obtain a more accurate binocular stereoscopic measurement. Then, the second correction parameter set CPS2 is used to correct the mapping of the three-dimensional information of the structured light pattern to the world coordinates to obtain more accurate three-dimensional information.

Referring to FIG. 2, in one embodiment of the disclosure, the incident angle θr of the structured light projected by the light source 10 to the transparent piece under test 40 ranges from 40 to 80 degrees. Because the diffuse reflection ratio of the surface of the transparent piece under test 40 is low, the reflected image cannot be obtained directly above the transparent piece under test 40. The first image sensing unit 21 and the second image sensing unit 22 are disposed on the path after the structured light pattern 11 is reflected by the surface of the transparent piece under test 40 to obtain the reflected structured light pattern. Therefore, the range of the incident angle θr cannot be too large, lest the structured light pattern reflected by the surface of the transparent piece under test 40 cannot fall within the field of view of the first image sensing unit 21 or the second image sensing unit 22.

Referring to FIG. 1, in one embodiment of the disclosure, the processing unit 30 further includes a circuit board 33, and the memory unit 31 and the computing unit 32 are disposed on the circuit board 33. In other embodiments, processing unit 30 may refer to, be part of, or include an application specific integrated circuit (ASIC), electronic circuitry, processor (shared, dedicated, or combined) and/or memory (shared, dedicated, or combined) for executing one or multiple software or firmware programs, combinational logic circuits, and/or other appropriate hardware components that provide the functions described. In some embodiments, the processing unit 30 may be implemented in one or more software or firmware modules, or circuit-related functions may be implemented in one or more software or firmware modules. In some embodiments, some or all components of the memory unit 31 and the computing unit 32 may be implemented together on a system on a chip (SOC).

Referring to FIG. 7, in one embodiment of the disclosure, the structured light pattern 11 is a gray code pattern.

Referring to FIG. 1 and FIG. 2, in one embodiment of the disclosure, the three-dimensional contour shape measuring system 100 further includes a position adjustment mechanism 12 for adjusting the position of the light source 10 so that the structured light pattern 11 can completely fall on the surface of the transparent piece under test 40.

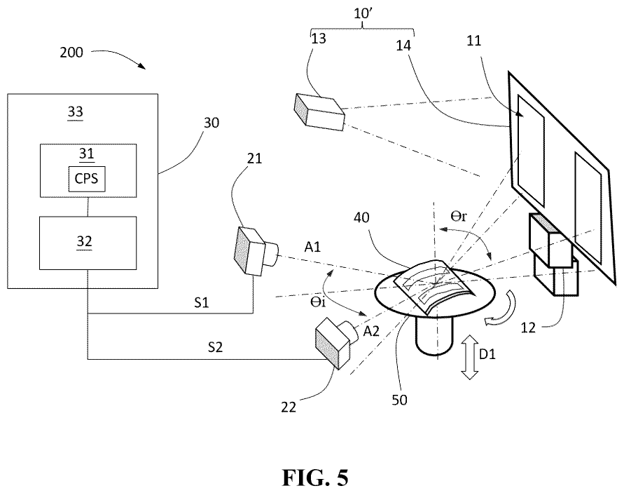

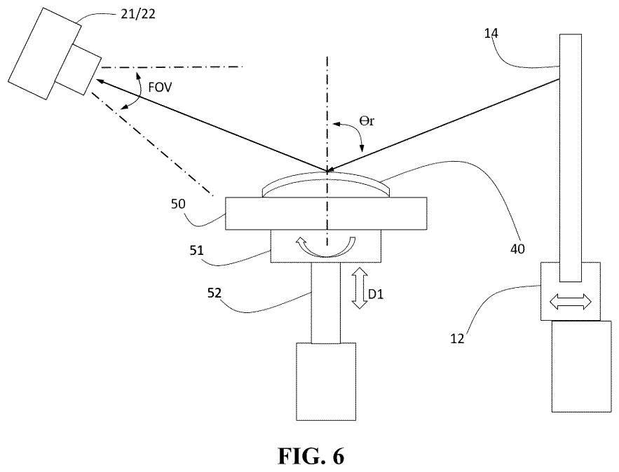

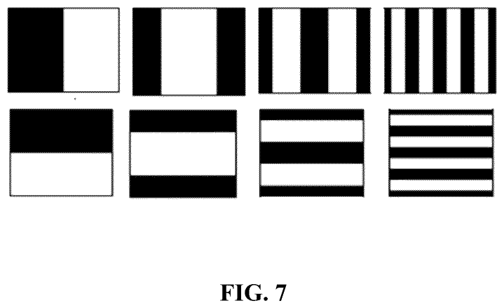

Referring to FIG. 5 and FIG. 6, the disclosure also provides a three-dimensional contour shape measuring system 200, including: a display unit 10′, a first image sensing unit 21, a second image sensing unit 22, and a processing unit 30. The display unit 10′ is configured to project a structured light pattern 11 onto a surface of a transparent piece under test 40. The first image sensing unit 21 is disposed on a side of the transparent piece under test 40 away from the display unit 10′ and is configured to obtain a first image information S1 of the structured light pattern 11 on the transparent piece under test 40. The second image sensing unit 22 is disposed adjacent to the first image sensing unit 21 and is configured to obtain a second image information S2 of the structured light pattern 11 on the transparent piece under test 40. An included angle θi between a central axis A2 of the second image sensing unit 22 and a central axis A1 of the first image sensing unit 21 ranges from 20 to 150 degrees. The processing unit 30 is electrically connected to the first image sensing unit 21 and the second image sensing unit 22. The processing unit 30 is configured to obtain three-dimensional information of the surface of the transparent piece under test by calculating with the first image information S1, the second image information S2, and a preset parameter PA.

In detail, the main difference between the three-dimensional contour shape measuring system 200 and the three-dimensional contour shape measuring system 100 is that the three-dimensional contour shape measuring system 200 uses the display unit 10′ to display the structured light pattern 11. For descriptions of other similar components, please refer to the description above and will not be repeated here. In one embodiment of the disclosure, the display unit 10′ may include a projector 13 and a projection screen 14. The projector 13 is, for example, an LED projector or a laser projector. The projector 13 may include display elements, such as digital light processing elements (DLP), three-chip liquid crystal display elements (3LCD), or liquid crystal on silicon (LCOS). In another embodiment, the display unit 10′ is, for example, a liquid crystal display or an OLED display.

In one embodiment of the disclosure, similar to the three-dimensional contour shape measuring system 100, the three-dimensional contour shape measuring system 200 further includes a platform 50 for placing the transparent piece under test 40. The platform 50 can move up and down along a vertical direction D1.

In one embodiment of the disclosure, the parameter PA includes a mapping parameter PA1 between spatial coordinates of character dots CD of a standard part 40S and images of the character dots CD obtained by the first image sensing unit 21 and the second image sensing unit 22, or includes a mapping parameter PA2 between the phase of the structured light pattern 11 and the spatial coordinate of the character dots CD and the images of the structured light pattern 11 obtained by the first image sensing unit 21 and the second image sensing unit 22.

Referring to FIG. 6, in one embodiment of the disclosure, similar to the three-dimensional contour shape measuring system 100, the incident angle θr of the structured light projected by the display unit 10′ to the transparent piece under test 40 ranges from 40 to 80 degrees.

Referring to FIG. 5, in one embodiment of the disclosure, similar to the three-dimensional contour shape measuring system 100, the processing unit 30 further includes a circuit board 33 and a memory unit 31 and a computing unit 32 disposed on the circuit board 33.

In one embodiment of the disclosure, similar to the three-dimensional contour shape measuring system 100, the three-dimensional contour shape measuring system 200 further includes a position adjustment mechanism 12 for adjusting the position of the display unit 10′.

Compared with the prior art, the disclosure provides a correction parameter set or preset parameters to correct the results of the three-dimensional shape measuring, so as to obtain more accurate measurement results more quickly and effectively and avoid the issues in the existing technology.

Although the disclosure has been shown and described with respect to one or more implementations, equivalent alterations and modifications will occur to those skilled in the art upon the reading and understanding of this specification and the annexed drawings. This disclosure includes all such modifications and variations and is limited only by the scope of the appended patent claims. In particular with respect to the various functions performed by the elements described above, terminology used to describe such elements is intended to correspond to any element (unless otherwise indicated) that performs the specified function of the element (e.g., which is functionally equivalent), even if there are no structural equivalents to the disclosed structures that perform the functions shown herein in the exemplary implementations of the specification. Furthermore, although a particular feature of this specification has been disclosed with respect to only one of several implementations, such a feature may be combined with one or more other features of other implementations that are desirable and advantageous for a given or particular application. Moreover, to the extent that the terms “comprise”, “has”, “comprising” or variations thereof are used in the detailed description or the claims, such terms are intended to be encompassed in a manner similar to the term “comprising”.

The above are only preferred embodiments of the present disclosure, and it should be pointed out that for those of ordinary skill in the art, without departing from the principle of the present disclosure, some improvements and modifications can also be made, and these improvements and modifications should also be regarded as protection scope of this disclosure.

What is claimed is:

1. A three-dimension contour shape measuring system, comprising:
a light source configured to project a structured light pattern onto a transparent piece under test;
a first image sensing unit, disposed at a side of the transparent piece under test opposite to a side of the transparent piece under test facing the light source, and configured to obtain first image information of the structured light pattern on the transparent piece under test;
a second image sensing unit, disposed at a side of the transparent piece under test opposite to a side of the transparent piece under test facing the light source, and configured to obtain second image information of the structured light pattern on the transparent piece under test, wherein an included angle between an axis of the second image sensing unit facing the transparent piece under test and an axis of the first image sensing unit facing the transparent piece under test ranges from 20 degrees to 150 degrees; and
a processing unit electrically connected to the first image sensing unit and the second image sensing unit, wherein the processing unit comprises a memory unit and a computing unit, the memory unit is configured to store a correction parameter set, and the computing unit is configured to receive the first image information and the second image information and obtain three-dimensional information of a surface of the transparent piece under test through the correction parameter set.

2. The three-dimension contour shape measuring system according to claim 1, further comprising a platform for disposing the transparent piece under test, wherein the platform is configured to move up and down along a vertical direction.

3. The three-dimension contour shape measuring system according to claim 2, wherein the platform comprising a rotating device and a linear moving device.

4. The three-dimension contour shape measuring system according to claim 1, wherein the correction parameter set comprises a first correction parameter set and a second correction parameter set, the first correction parameter set comprises mapping parameters between spatial coordinates of character dots of a standard part and an images of the character dots obtained by the first image sensing unit and the second image sensing unit, and the second correction parameter set comprises mapping parameters between phase of the structured light pattern and the spatial coordinates of the character dots of the standard part and an image of the structured light pattern obtained by the first image sensing unit and the second image sensing unit.

5. The three-dimension contour shape measuring system according to claim 1, wherein an incident angle of a structured light beam from the light source to the transparent piece under test ranges from 40 degrees to 80 degrees.

6. The three-dimension contour shape measuring system according to claim 1, wherein the processing unit comprises a circuit board and the memory unit and the computing unit are disposed on the circuit board.

7. The three-dimension contour shape measuring system according to claim 1, wherein the structured light pattern is of a gray code pattern.

8. The three-dimension contour shape measuring system according to claim 1, further comprising a position adjustment mechanism for adjusting a position of the light source.

9. A three-dimension contour shape measuring system, comprising:
a display unit configured to project a structured light pattern onto a surface of a transparent piece under test;
a first image sensing unit, disposed at a side of the transparent piece under test away from the display unit, and configured to obtain first image information of the structured light pattern on the transparent piece under test;
a second image sensing unit, disposed nearby the first image sensing unit, and configured to obtain second image information of the structured light pattern on the transparent piece under test, wherein an included angle between a central axis of the second image sensing unit and a central axis of the first image sensing unit ranges from 20 degrees to 150 degrees; and
a processing unit electrically connected to the first image sensing unit and the second image sensing unit, wherein the processing unit is configured to obtain three-dimensional information of the surface of the transparent piece under test by calculating with the first image information, the second image information, and a preset parameter.

10. The three-dimension contour shape measuring system according to claim 9, further comprising a platform for disposing the transparent piece under test, wherein the platform is configured to move up and down along a vertical direction.

11. The three-dimension contour shape measuring system according to claim 10, wherein the platform comprising a rotating device and a linear moving device.

12. The three-dimension contour shape measuring system according to claim 9, wherein the preset parameter comprises a mapping parameter between spatial coordinates of character dots of a standard part and an images of the character dots obtained by the first image sensing unit and the second image sensing unit, or a mapping parameter between phase of the structured light pattern and the spatial coordinates of the character dots of the standard part and an image of the structured light pattern obtained by the first image sensing unit and the second image sensing unit.

13. The three-dimension contour shape measuring system according to claim 9, wherein an incident angle of a structured light beam from the display unit to the transparent piece under test ranges from 40 degrees to 80 degrees.

14. The three-dimension contour shape measuring system according to claim 9, wherein the processing unit comprises a circuit board and a memory unit and a computing unit disposed on the circuit board.

15. The three-dimension contour shape measuring system according to claim 9, wherein the structured light pattern is of a gray code pattern.

16. The three-dimension contour shape measuring system according to claim 9, further comprising a position adjustment mechanism for adjusting a position of the display unit.
